(19) United States
(12) Patent Application Publication
(10) Pub. No.: US 2025/0236430 A1
(43) Pub. Date: Jul. 24, 2025

(54) LABEL AFFIXING DEVICE

(71) Applicant: BROTHER KOGYO KABUSHIKI KAISHA, Nagoya (JP)

(72) Inventor: Shota IIJIMA, Nagoya (JP)

(21) Appl. No.: 19/028,300

(22) Filed: Jan. 17, 2025

(30) Foreign Application Priority Data
Jan. 19, 2024 (JP) 2024-007032

(51) Int. Cl. B65C 9/26; B65C 3/02; B65C 9/18; B65C 9/46

(52) U.S. Cl. CPC B65C 9/26; B65C 3/02; B65C 9/1807; B65C 9/1892; B65C 9/46

(57) ABSTRACT

A label affixing device includes a wrapping portion, a housing, and an attachment portion. With wrapping portion, an adherend to which a portion of a label to be affixed is affixed is inserted into the insertion position. The wrapping portion then rotates to wrap the label around the adherend and affix it. The housing rotatably supports the wrapping portion. The attachment portion is provided with a bar member disposed on the housing, and accepts an attachment of a clip sandwiching and holding a holding member. The label affixing device can be held on a rack or the like by the clip. The label affixing device can stably affix a label to an adherend while the label affixing device is held to a holding member by a clip attached to an attachment portion. The label application device can be stably supported by the clip and the rear surface of the housing.

### REFERENCE TO RELATED APPLICATIONS

This application claims priority from Japanese Patent Application No. 2024-007032 filed on Jan. 19, 2024. The entire content of the priority application is incorporated herein by reference.

### BACKGROUND ART

The present disclosure relates to a label affixing device that affixes a label to an adherend.

A label printer that has a clip on a back surface of a device main body is conventionally known. A user can wear the label printer by inserting a belt or the like of the user between the clip and the device main body.

### SUMMARY

Various embodiments herein provide a first aspect of a label affixing device including a rotation body, a housing, and an attachment portion. The rotation body is configured such that an adherend to which a portion of a label that is an object to be affixed has been affixed is inserted to an insertion position. The rotation body is configured to wrap and affix the label around the adherend by rotating. The housing is configured to rotatably support the rotation body. The attachment portion is provided with a bar member disposed on the housing, and is configured to accept an attachment of a clip sandwiching and holding a holding member.

Various embodiments also provide a second aspect of a label affixing device including a rotation body, a housing, and a clip. The rotation body is configured such that an adherend to which a portion of a label that is an object to be affixed has been affixed is inserted to an insertion position. The rotation body is configured to wrap and affix the label around the adherend by rotating. The housing is configured to rotatably support the rotation body. The clip is disposed on the housing and is configured to sandwich and hold a holding member. And, the label affixing device according to the second aspect displays the same effect as the label affixing device according to the first aspect.

### BRIEF DESCRIPTION OF DRAWINGS

FIG. 1 is a perspective view of a label affixing device viewed from the upper right front.

FIG. 2 is a front view of the label affixing device.

FIG. 3 is a right side view of the label affixing device.

FIG. 4 is a left side view of the label affixing device.

FIG. 5 is a perspective view of the label affixing device viewed from the upper right rear.

FIG. 6 is a bottom view of the label affixing device.

FIG. 7 is a perspective view of the label affixing device with a compartment cover open.

FIG. 8 is a right side view of the label affixing device with the compartment cover open.

FIG. 9 is an enlarged cross-sectional view of a two-dot chain line in FIG. 8.

FIG. 10 is a perspective cross-sectional view of a cross section of the label affixing device cut along line I-I in FIG. 2 viewed from the upper right rear.

FIG. 11 is a perspective view of a cutting portion viewed from the upper left front.

FIG. 12 is a front view of a full-cut cutting blade.

FIG. 13 is an enlarged cross-sectional view of the two-dot line in FIG. 8, and an enlarged view of a pressing portion when a cable has reached a position lower than a guide surface.

FIG. 14 is a cross-sectional view in an axial direction of a winding portion when an operation portion is in a locked position.

FIG. 15 is a cross-sectional view in an axial direction of the winding portion when the operation portion is in a released position.

### DESCRIPTION

With a conventional label affixing device that affixes a label to an adherend, a user holds the adherend in their hands and performs an operation of pressing the adherend against a wrapping portion of the label affixing device. Therefore, it is difficult to maintain balance during operation and stably apply labels simply by attaching a clip to a housing of the label affixing device.

The following describes a label affixing device that can stably affix a label to an adherend while the label affixing device is held to a holding member by a clip attached to an attachment portion.

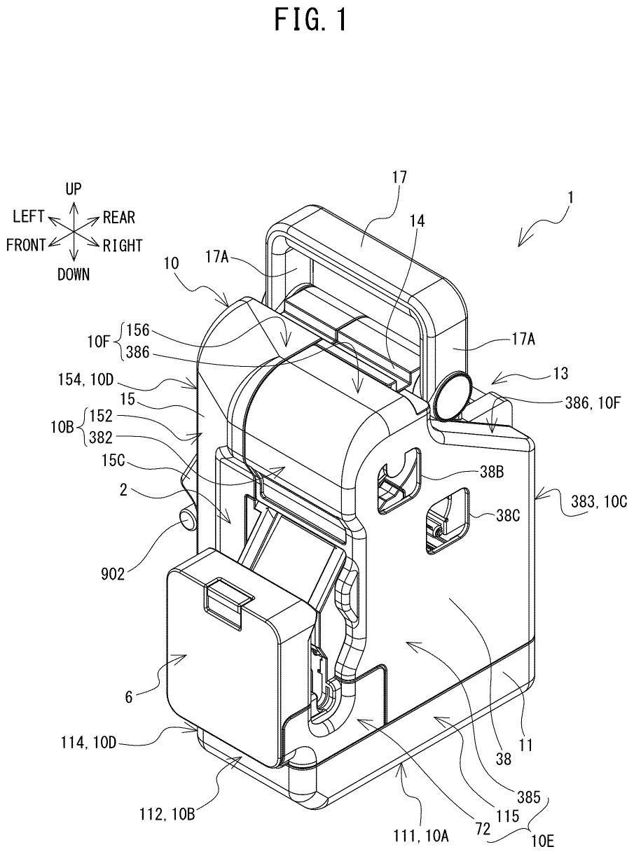

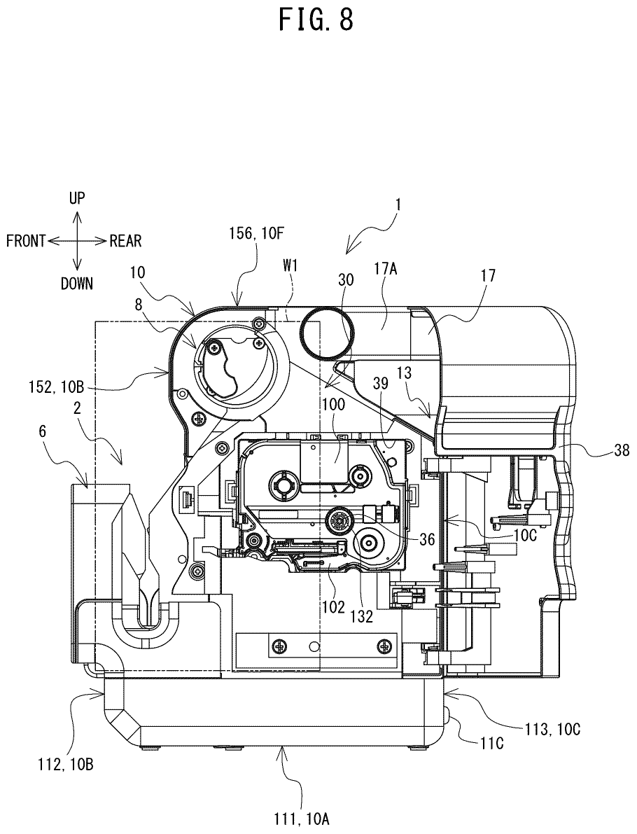

An embodiment of a label affixing device 1 embodying the present disclosure will be described with reference to the drawings. The referenced drawings are used to illustrate technological features that can be adopted by the present disclosure, and illustrated configurations of devices and the like are not intended to limit the present disclosure, and are simply explanatory examples. The label affixing device 1 is a device for producing a label 160 by performing printing on a tape 150 of a tape cassette 100 (refer to FIG. 8), for wrapping the produced label 160 around a cable 19 and affixing the label 160 to the cable 19. Hereinafter, a lower left direction, an upper right direction, an upper left direction, a lower right direction, and upward direction, and a downward direction in FIG. 1 are, respectively, a front direction, a rear direction, a left direction, a right direction, an upward direction, and a downward direction of the label affixing device 1.

### Overview of Label Affixing Device 1

As shown in FIG. 1 to FIG. 6, the label affixing device 1 includes a box-shaped housing 10. The housing 10 includes a base 11, a main unit 2, a main plate (not shown in the drawings), a left cover 15, a rear cover 16, a compartment cover 38, a compartment 30, a print portion 3, and a cutting portion 9.

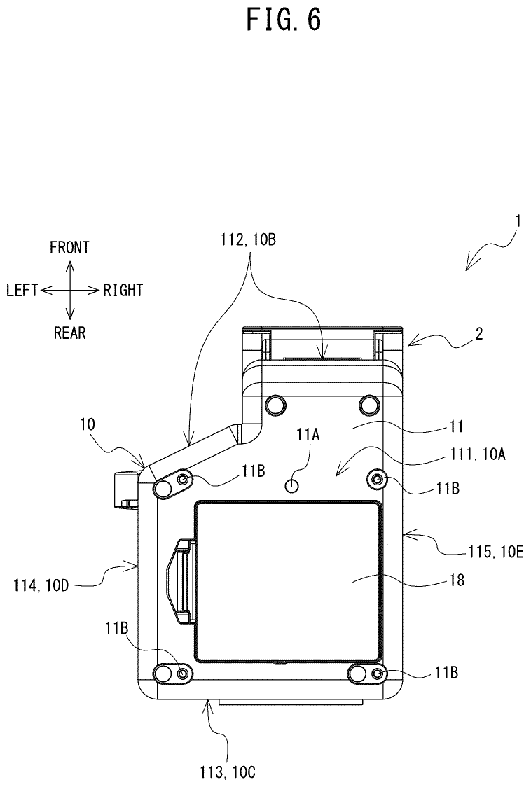

The base 11 is a foundation of the label affixing device 1. The base 11 is a rectangular box shape, and is a shape in which a left front corner portion is missing when viewed from the bottom (refer to FIG. 6). A bottom wall 111 of the base 11 forms a bottom surface 10A of the housing 10. A front wall 112, a rear wall 113, a left wall 114, and a right wall 115 of the base 11 protrude upward in plate shapes from a front end, a rear end, a left end, and a right end, respectively, of the bottom wall 111. The front wall 112, the rear wall 113, the left wall 114, and the right wall 115 form a front surface 10B, a rear surface 10C, a left surface 10D, and a right surface 10E, respectively, of a lower end portion of the housing 10. A power supply board, a battery, and the like (not shown in the drawings) are housed inside the base 11. An installation opening for the battery is provided in the bottom wall 111, and is closed in a manner able to be open and closed by a battery cover 18. Also, a camera mount 11A and a VESA mount 11B are provided on the bottom wall 111. “VESA mount” is a registered trademark of the Video Electronics Standards Association (VESA). A camera stand or the like can be attached to the camera mount 11A. The VESA mount 11B can be fitted with hardware, an arm, a stand, etc., whose attachment portion is designed to be 100×100 mm in size by VESA standards, for example.

The main unit 2 is a unit for peeling the label 160 from the tape 150 printed in the print portion 3 (to be described later), and for wrapping the label 160 around the cable 19. The main unit 2 includes a peeling portion 4, a pressing portion 5, an opening/closing member 6, and a wrapping portion 7 (to be described later). The lower end portion of the main unit 2 is arranged on the front in the front-rear direction and on the right in the left-right direction of the base 11 and is fixed to the base 11. The main unit 2 will be described later.

The main plate is a plate-shaped support member that extends in the up-down direction and the front-rear direction, and is disposed at a position further to the left than the center in the left-right direction of the base 11, and extends upward. The lower end portion of the main plate is fixed to the lower end portion of the main unit 2, inside the base 11. The right surface of the main plate supports a drive portion (not shown in the drawings), a cassette compartment 39 in the compartment 30, the print portion 3, and the winding portion 8, the front end portion of the main plate supports the cutting portion 9, and the left surface of the main plate supports a controller (not shown in the drawings). The controller controls the operation of the label affixing device 1. The drive portion drives the print portion 3.

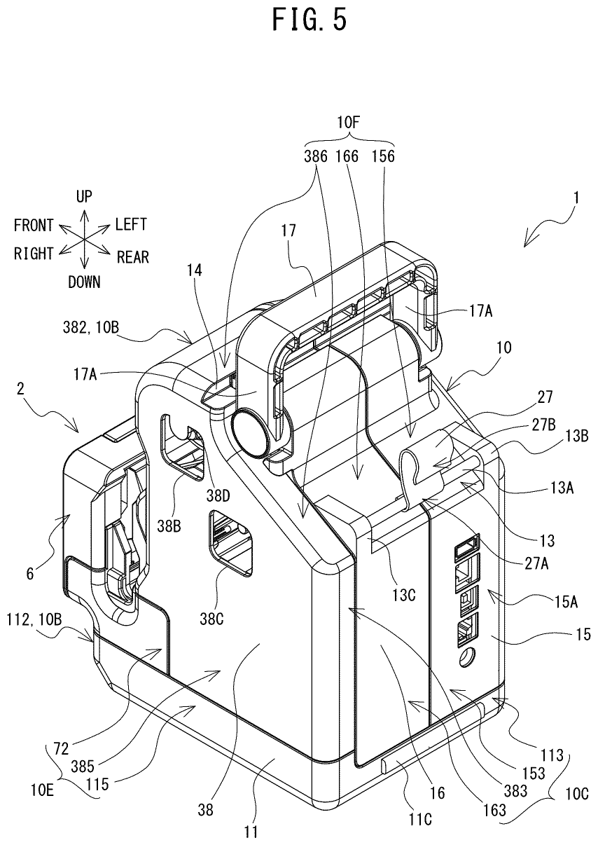

The left cover 15 includes a plate-shaped left wall 154, which is disposed on the left of the main plate. The left wall 154 forms a portion of the left surface 10D of the housing 10. A front wall 152, a rear wall 153, and a top wall 156 of the left cover 15 protrude from the front end, the rear end, and the upper end, respectively, of the left wall 154 in a plate shape to the right toward the center in the left-right direction of the housing 10. The front wall 152, the rear wall 153, and the top wall 156 form portions of the front surface 10B, the rear surface 10C, and a top surface 10F, respectively, that are to the left of the center in the left-right direction of the housing 10. A portion of the top wall 156 that is on the front faces upward, and a portion of the top wall 156 that is on the rear is inclined and faces diagonally upward toward the rear. The left cover 15 covers and protects the controller disposed on the left surface of the main plate. Connection ports 15A (refer to FIG. 5) for a power supply cable and various connecting cables provided with the controller are located on the rear surface 10C. The rear cover 16 includes a plate-shaped rear wall 163 and is disposed on the right of the main plate. The rear wall 163 forms a portion of the rear surface 10C of the housing 10 that is to the right of the center in the left-right direction. A top wall 166 of the rear cover 16 protrudes in a plate shape toward the front of the housing 10 from the upper end of the rear wall 163. The top wall 166 forms a portion of the top surface 10F of the housing 10 that is to the right of the center in the left-right direction.

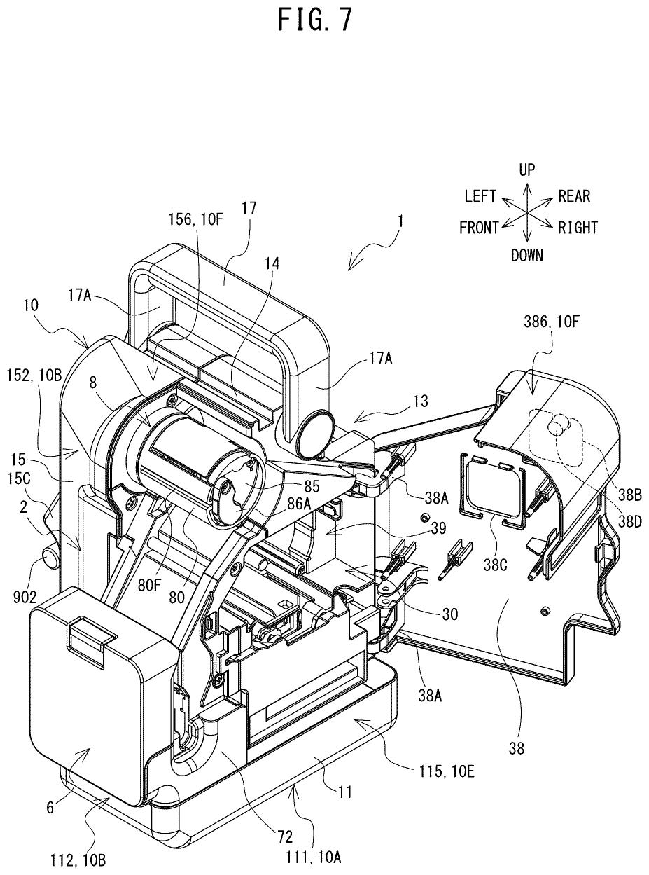

The compartment cover 38 includes a plate-shaped right wall 385, which is disposed on the right of the main plate. The right wall 385 forms the right surface 10E of the housing 10. The compartment cover 38 covers and protects the compartment 30. The compartment 30 includes the cassette compartment 39, the print portion 3, the winding portion 8, a first guide path 231, and a second guide path 236. The cassette compartment 39 is provided on the right of the main plate. The print portion 3 is disposed in a lower portion of the cassette compartment 39. The first guide path 231 and the second guide path 236 are arranged on the left of the cassette compartment 39. A front wall 382, a rear wall 383, and a top wall 386 of the compartment cover 38 protrude in a plate shape to the left toward the center in the left-right direction of the housing 10 from the front end, the rear end, and the upper end, respectively, of the right wall 385. The front wall 382, the rear wall 383, and the top wall 386 form portions of the front surface 10B, the rear surface 10C, and the top surface 10F, respectively, that are to the right of the center in the left-right direction of the housing 10. The portion of the top wall 386 on the front faces upward, and the portion of the top wall 386 on the rear is inclined and faces diagonally upward toward the rear. A portion formed by the portions on the front of the right wall 385 and the top wall 386 and the front wall 382 cover and protect the winding portion 8. A hinge 38A (refer to FIG. 7) rotatably supported by a left end portion front surface of the rear cover 16 is provided in two locations in the up-down direction on a rear end of the compartment cover 38. Accordingly, the compartment cover 38 opens and closes the cassette compartment 39 by the front end pivoting in the left-right direction with the rear end as the axis. Viewing windows 38B and 38C are formed in two locations in the right wall 385 of the compartment cover 38. The viewing window 38B is formed in an upper front portion of the right wall 385 so that a user can check the amount of the tape 150 wound on a reel 80 of the winding portion 8 through the viewing window 38B. The viewing window 38C is formed in substantially the center of the right wall 385 so that the user can check a cassette label that is affixed to the surface of the tape cassette 100 and an indicates the type of the tape 150, as well as check the remaining amount of the tape 150 housed inside the tape cassette 100, through the viewing window 38C.

The housing 10 has a handle 17 used to carry the label affixing device 1, on the top wall 156 of the left cover 15 and the top wall 166 of the rear cover 16. The handle 17 extends in the left-right direction and is disposed in substantially the center in the front-rear direction of the housing 10. The handle 17 rotates between upright and rearward by arm portions 17A extending from both ends pivoting on a rotation shaft extending in the left-right direction provided on each of a left end portion of the top wall 156 of the left cover 15 and a right end portion of the top wall 166 of the rear cover 16. The user can grab the handle 17 by inserting a hand between the handle 17 and the top walls 156 and 166 (top surface 10F of the housing), and carry the label affixing device 1.

A groove 14 extending in the left-right direction is formed in front of the handle 17 in the top walls 156 and 166. The groove 14 is formed as a holder for placing a mobile device such as a smartphone or a tablet, for example. The user can wirelessly send print data for a label design created with a mobile device to the label affixing device 1 and print the label 160.

The housing 10 has an attachment portion 13 to which a clip 27 can be attached, on a corner portion of the rear end portion of the top wall 156 of the left cover 15 and the top wall 166 of the rear cover 16, and an upper end portion of the rear wall 153 of the left cover 15 and the rear wall 163 of the rear cover 16. The attachment portion 13 has a round bar-shaped attachment bar 13A that extends in the right-left direction, and fixing portions 13B and 13C that support both ends of the attachment bar 13A. The fixing portion 13B is provided on a corner portion of a left end portion upper end of the rear wall 153 of the left cover 15, and a left end portion rear end of an inclined portion of the top wall 156. The fixing portion 13C is provided on a corner portion of a right end portion upper end of the rear wall 163 of the rear cover 16, and a right end portion rear end of an inclined portion of the top wall 166. The attachment bar 13A is supported at both end portions by the fixing portions 13B and 13C, and a center portion of the attachment bar 13A is arranged at an upper end portion of the rear surface 10C of the housing 10. The attachment bar 13A is a metal pin extending parallel to a rotational axis center 70A of a rotation body 70 of the wrapping portion 7. The clip 27 can be attached to the attachment bar 13A from the direction of the rear surface 10C of the housing 10. The clip 27 is an elastic place-shaped hook bent in an S-shape when viewed from the side. The clip 27 attaches to the attachment portion 13 by one end portion 27A hooking around the attachment bar 13A, and holds the label affixing device 1 to a holding member by either clamping or hooking another end 27B onto an edge of a desk or a rack, or onto a holding member such as a belt of the user,

The cassette compartment 39 is provided at substantially the center, in the front-rear direction and the up-down direction, of the housing 10, on the right surface of the main plate. As shown in FIG. 7 to FIG. 10, the cassette compartment 39 has a box shape that is open to the right and can accept a plurality of types of tape cassettes, such as a thermal type, a receptor type, a laminate type, and the like. The thermal-type tape cassette is provided with a heat-sensitive paper tape. The receptor-type tape cassette is provided with a tape and an ink ribbon. The tape cassette used in the label affixing device 1 according to the present embodiment is the laminate-type tape cassette 100. The laminate-type tape cassette 100 is provided with a film tape 110, a double-sided adhesive tape 120, and an ink ribbon 130. The film tape 110 is a transparent PET tape. The double-sided adhesive tape 120 is a tape in which a base material (not shown in the drawings) and a release material 170 are laminated via an adhesive. The tape cassette 100 will be described later.

### Print Portion 3

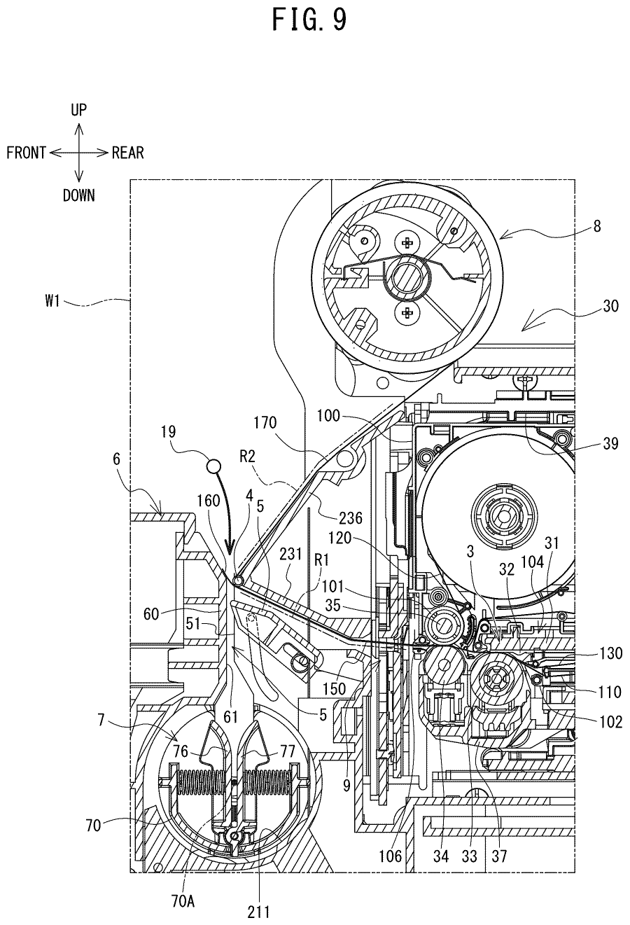

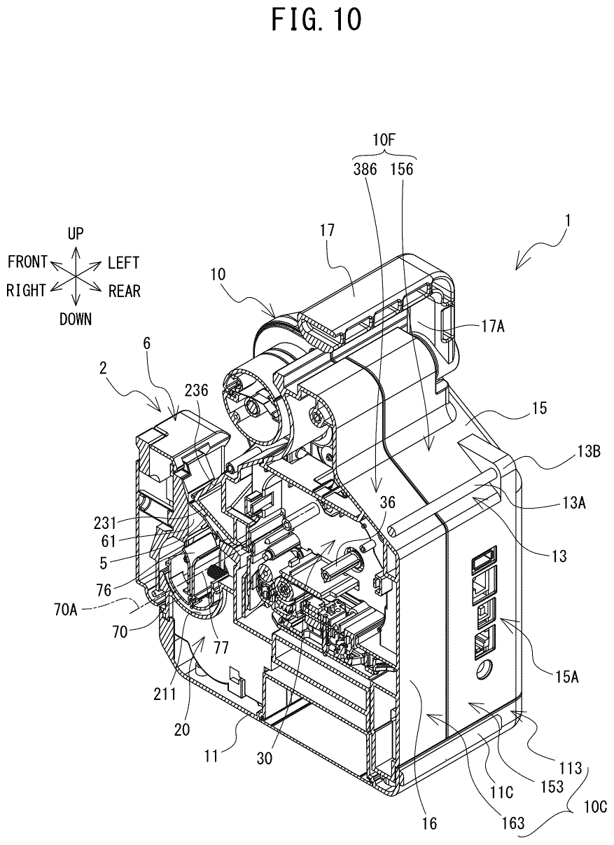

As shown in FIG. 9, the print portion 3 is provided below the cassette compartment 39. The print portion 3 is provided with a head holder 31, a thermal head 32, a platen roller 33, a transport roller 34, a drive shaft 35, and a winding shaft 36 (refer to FIG. 10). The head holder 31 is provided below the cassette compartment 39. The head holder 31 has a plate shape, and extends in the front-rear direction and the left-right direction. The thermal head 32 is provided on the lower surface of the head holder 31. The thermal head 32 is provided with a plurality of heating elements (not shown in the drawings). The plurality of heating elements are aligned in a row in the left-right direction. In a state in which the tape cassette 100 is installed in the cassette compartment 39, the thermal head 32 heats the ink ribbon 130 using the plurality of heating elements, and transfers ink to the film tape 110. Along with supporting the thermal head 32, the head holder 31 functions as a heat sink for the heating elements.

The drive shaft 35 for transporting the tape 150 is provided diagonally above and to the front of the head holder 31. The drive shaft 35 extends to the right from the bottom surface of a recess portion of the cassette compartment 39, and is driven to rotate by the driving force of a transport motor (not shown in the drawings). When the tape cassette 100 is installed, the drive shaft 35 engages with a shaft hole of a drive roller 101 of the tape cassette 100. The winding shaft 36 is provided diagonally above and to the rear of the head holder 31. The winding shaft 36 is driven to rotate by the driving force of the transport motor. When the tape cassette 100 is installed, the winding shaft 36 engages with a winding spool 132 (refer to FIG. 8) of the tape cassette 100.

A platen holder 37 is provided below the head holder 31. The platen holder 37 has an arm shape, and is supported to be rotatable around a support shaft extending in the left-right direction. The support shaft is provided at the rear end of the platen holder 37. The platen roller 33 and the transport roller 34 are rotatably supported at the front end of the platen holder 37. The platen roller 33 approaches and moves away from the thermal head 32 in accordance with swinging of the platen holder 37. The transport roller 34 is provided to the left of the platen roller 33. The transport roller 34 approaches and moves away from the drive roller 101 of the tape cassette 100, in accordance with the swinging of the platen holder 37. In conjunction with the opening and closing of the compartment cover 38, the platen holder 37 swings between a stand-by position and a printing position. When the compartment cover 38 is opened, the platen holder 37 moves to the stand-by position. The stand-by position is a position at which the platen roller 33 and the transport roller 34 are separated from the cassette compartment 39. When the platen holder 37 has moved to the stand-by position, a user can install or remove the tape cassette 100 into or from the cassette compartment 39. When the compartment cover 38 is closed, the platen holder 37 moves to the printing position. The printing position is a position at which the platen roller 33 and the transport roller 34 are closer to the cassette compartment 39. At the printing position, the platen roller 33 presses the film tape 110 and the ink ribbon 130 against the thermal head 32, and the transport roller 34 presses the double-sided adhesive tape 120 and the film tape 110 against the drive roller 101 in a state in which the film tape 110 and double-sided adhesive tape 120 are overlaid with each other.

The tape cassette 100 houses the film tape 110, the double-sided adhesive tape 120, and the ink ribbon 130 in a box-shaped case. An arm portion 102 is provided in the lower portion of the case. The arm portion 102 extends from the lower rear portion to the lower front portion of the case. The film tape 110 pulled off of a film spool (not shown in the drawings) and the ink ribbon 130 pulled off of a ribbon spool (not shown in the drawings) are pulled outside of the case through an open portion formed in a left end of the arm portion 102, and are overlaid with each other.

A head insertion portion 104 is formed above the arm portion 102. The head insertion portion 104 penetrates the case in the up-down direction. In the state in which the tape cassette 100 is installed in the cassette compartment 39, the head holder 31 is inserted into the head insertion portion 104. The drive roller 101 is positioned to the front of the head insertion portion 104. The drive roller 101 has a cylindrical shape and extends in the left-right direction. The lower end portion of the drive roller 101 is exposed downward from the case. The driver roller 101 supports the double-sided adhesive tape 120 in a state in which the film tape 110 and the double-sided adhesive tape 120 are overlaid with each other. In the state in which the tape cassette 100 is installed in the cassette compartment 39, the drive shaft 35 is inserted into the shaft hole of the drive roller 101. The drive roller 101 rotates in accordance with the rotational driving of the drive shaft 35 and transports the film tape 110 and the double-sided adhesive tape 120 in a state pinched between the drive roller 101 and the transport roller 34.

The guide portion 106 is provided at a corner portion diagonally downward and at the front of the case. The guide portion 106 is disposed further downstream (to the front) than the drive roller 101 in the transport direction of the film tape 110. The guide portion 106 is formed in a slit shape extending in the left-right direction. The tape 150, which is formed by the double-sided adhesive tape 120 being affixed to the film tape 110, is transported by the drive roller 101 and passes through the inside of the guide portion 106. The guide portion 106 supports the tape 150 from both sides in the width direction. In this way, the tape 150 is discharged from the tape cassette 100 in a state in which the posture of the tape 150 is held.

At the time of printing by the print portion 3, the platen holder 37 moves from the stand-by position to the printing position. The platen roller 33 presses the film tape 110 and the ink ribbon 130 in the overlaid state against the thermal head 32. The platen roller 33 rotates and transports the film tape 110 toward the front. At the same time, the thermal head 32 produces heat, and the ink ribbon 130 is heated. In this way, the ink of the ink ribbon 130 is transferred to a print surface (the surface facing the thermal head 32 (the upward) in the case) of the film tape 110. As a result, an image including characters and the like is printed on the film tape 110. After the printing, the ink ribbon 130 separates from the film tape 110, and is wound up by the winding spool 132.

The double-sided adhesive tape 120 is overlaid with the print surface of the film tape 110 that has been printed. The base material of the double-sided adhesive tape 120 comes into contact with the print surface of the film tape 110. In this state, the film tape 110 and the double-sided adhesive tape 120 pass between the drive roller 101 and the transport roller 34, in a state in which the film tape 110 is disposed below the double-sided adhesive tape 120. As a result of the film tape 110 being affixed to the base material by the adhesive, the printed label 160 is produced. The upper surface of the label 160 corresponds to an adhesive surface to which the adhesive of the base material is adhered, and a state is obtained in which the release material 170 is affixed to the adhesive surface. In other words, as a result of the double-sided adhesive tape 120 being affixed to the film tape 110, the tape 150 is produced in a state in which the release material 170 is affixed to the label 160. The width direction of the tape 150 corresponds to the left-right direction. A transport path of the tape 150 that is transported from the print portion 3, passes through the cutting portion 9, and is transported to the peeling portion 4 will be referred to as a “transport path R1”.

### Cutting Portion 9

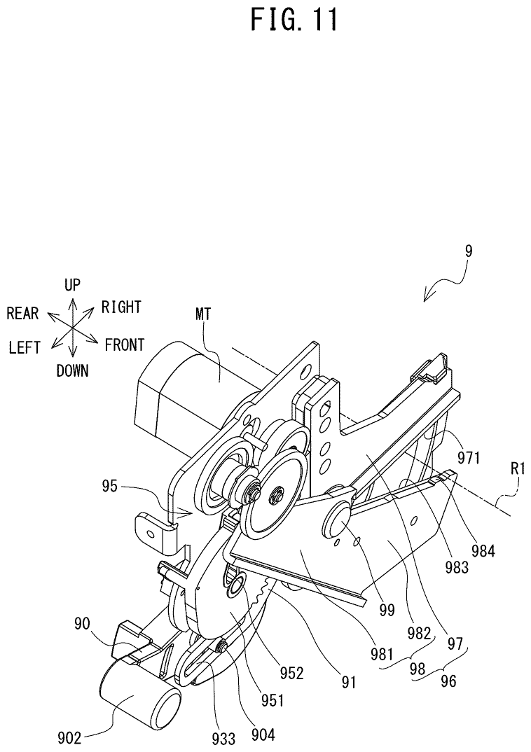

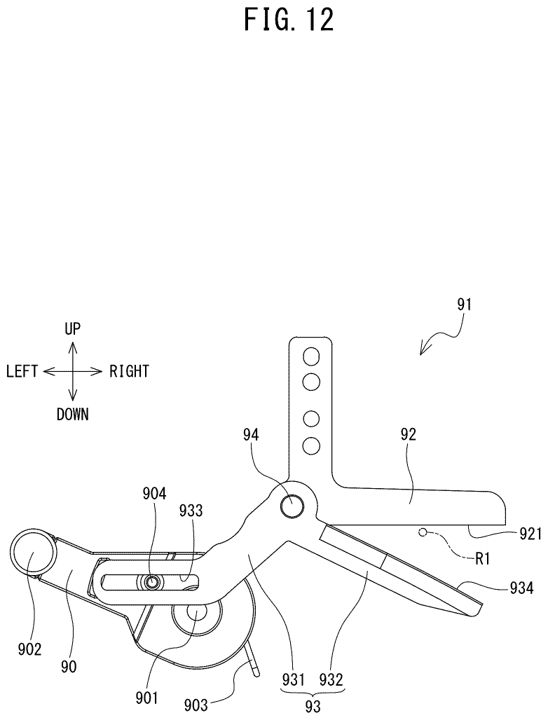

As shown in FIG. 11 and FIG. 12, the cutting portion 9 is disposed downstream of the transport roller 34 of the print portion 3 in the transport direction of the tape 150. The cutting portion 9 includes the full-cut cutting blade 91 and the half-cut cutting blade 96. The full-cut cutting blade 91 includes a fixed blade 92 that is fixed at a position higher than the transport path R1, and a movable blade 93 that can rotate at a position lower than the transport path R1. The fixed blade 92 extends in the left-right direction, and a cutting edge 921 faces downward. The movable blade 93 has a plate shape extending bent, and is rotatably supported by a rotation shaft 94. The rotation shaft 94 is provided to the left of the transport path R1 and extends in the front-rear direction. The movable blade 93 includes a left end portion 931 extending bent toward the left of the rotation shaft 94, and a right end portion 932 extending straight toward the right of the rotation shaft 94. The left end portion 931 has a long hole 933. The right end portion 932 faces toward the right with a cutting edge 934 extending in the left-right direction facing upward.

The cutting portion 9 has a lever 90 to the left of the transport path R1 and to the rear of the full-cut cutting blade 91. The lever 90 extends in the left-right direction and a right end portion thereof is rotatably supported by a rotation shaft 901. The rotation shaft 901 is provided diagonally downward to the left of the rotation shaft 94, and extends in the front-rear direction. A torsion spring 903 is provided around the rotation shaft 901 on the rear surface of the lever 90. The torsion spring 903 urges the lever 90 in the clockwise direction in a front view with the rotation shaft 901 as a fulcrum. An operation portion 902 is provided on a left end portion of the lever 90. The operation portion 902 protrudes in a circular cylindrical shape toward the front on the left end portion of the lever 90. A pin 904 that engages with the long hole 933 in the movable blade 93 is provided between the rotation shaft 901 and the operation portion 902 of the lever 90.

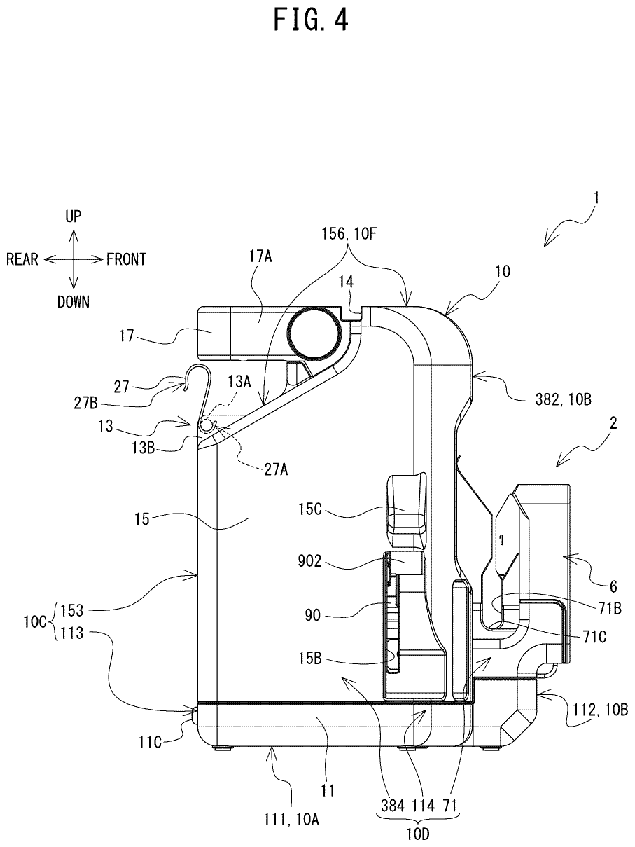

As shown in FIG. 4, the left cover 15 of the housing 10 has an open portion 15B that extends in the up-down direction in a portion diagonally downward to the front of the left wall 154. The lever 90 that rotates the movable blade 93 of the full-cut cutting blade 91 is inserted into the open portion 15B. The operation portion 902 is exposed to the left of the left wall 154 of the left cover 15 so that it can be operated by the user. A protrusion 15C that protrudes to the left from the left wall 154 of the left cover 15 is provided above the open portion 15B. When the movable blade 93 of the full-cut cutting blade 91 is in the stand-by position, the operation portion 902 of the lever 90 moves to the upper end of the open portion 15B and is positioned at the far left. The protrusion 15C protrudes farther than the operation portion 902 protrudes to the left of the left wall 154 of the left cover 15 when the movable blade 93 is in the stand-by position. In other words, even if the protrusion 15C or the left wall 154 of the label affixing device 1 were to hit an obstacle or the like, the operation portion 902 would not contact the obstacle, so damage would be inhibited, because the protrusion 15C protrudes farther to the left than the operation portion 902.

As shown in FIG. 11 and FIG. 12, when the operation portion 902 is pushed downward, the lever 90 rotates counterclockwise in a front view with the rotation shaft 901 as the fulcrum. The pin 904 moves downward, pushing the long hole 933 down. The movable blade 93 rotates counterclockwise in a front view with the rotation shaft 94 as the fulcrum, and moves to the cutting position. The cutting position is a position in which, in a front view, the movable blade 93 rotates counterclockwise from the stand-by position, and the cutting edge 934 of the right end portion 932 intersects with the cutting edge 921 of the fixed blade 92. When no operation is performed on the operation portion 902, the lever 90 moves to the stand-by position from the urging of the torsion spring 903. The stand-by position is a position in which, in a front view, the movable blade 93 rotates in the clockwise direction from the cutting position, and the cutting edge 934 of the right end portion 932 retracts below the transport path R1. The full-cut cutting blade 91 cuts the tape 150 (a full cut) by moving the cutting edge 934 of the movable blade 93 upward across the transport path R1 from below the transport path R1 with respect to the cutting edge 921 of the fixed blade 92.

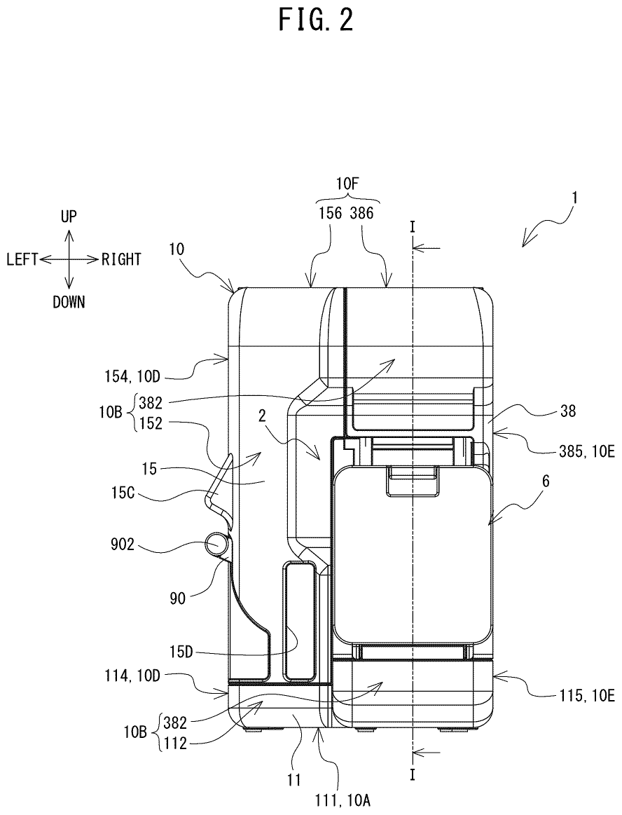

As shown in FIG. 2, the left cover 15 has a recess portion 15D in a portion diagonally downward to the right of the front wall 152. The recess portion 15D extends in the up-down direction and is provided at a position slightly lower position than the open portion 15B. When operating the full-cut cutting blade 91, the user can reliably apply the necessary load for cutting the tape 150 to the lever 90 by placing their hand on the recess portion 15D and pushing down the operation portion 902 with their thumb.

The half-cut cutting blade 96 is provided on the downstream of the full-cut cutting blade 91 in the transport path R1. The half-cut cutting blade 96 includes a fixed base 97 fixed above the transport path R1, and a movable blade 98 that can rotate below the transport path R1. The fixed base 97 has a blade contact surface 971 that extends in the left-right direction, and faces downward, i.e., toward the transport path R1. The movable blade 98 has a plate shape that extends in the left-right direction and is supported by a rotation shaft 99. The rotation shaft 99 is provided to the left of the transport path R1 and extends in the front-rear direction. The movable blade 98 has a left end portion 981 that extends straight to the left of the rotation shaft 99, and a right end portion 982 that extends straight to the right of the rotation shaft 99. The left end portion 981 has a pin (not shown in the drawings) that protrudes toward the rear on an end portion thereof. The right end portion 982 faces upward, and a cutting edge 983 that extends in the left-right direction faces upwards. A protrusion 984 that protrudes slightly above the cutting edge 983 is formed on the end portion of the right end portion 982. The amount the protrusion 984 protrudes above the cutting edge 983 is substantially the same as the thickness of the release material 170.

The cutting portion 9 has, to the left of the transport path R1 and to the rear of the half-cut cutting blade 96, a transmitting portion 95 that transmits the driving force of a motor MT to the movable blade 98. The transmitting portion 95 has a plurality of gear sets and the drive shaft of the motor MT meshes with the uppermost gear. A lowermost drive gear 951 of the transmitting portion 95 has a long groove 952 with which a pin of the left end portion 981 of the movable blade 98 engages. The long groove 952 extends from near the rotation center of the drive gear 951 toward the outer periphery thereof. The motor MT rotates the drive gear 951 and moves the pin in the long groove 952, thereby moving the movable blade 98 between the cutting position and the stand-by position. The cutting position is a position in which the movable blade 98 rotates in the counterclockwise direction from the stand-by position in a front view, and the protrusion 984 on the right end portion 982 abuts against the blade contact surface 971 of the fixed base 97. In this case, a gap equal to the thickness of the release material 170 is formed between the cutting edge 983 of the movable blade 98 and the blade contact surface 971. The stand-by position is a position in which the movable blade 98 rotates in the clockwise direction from the cutting position in a front view, and the cutting edge 983 of the right end portion 982 retracts below the transport path R1. Because the gap equal to the thickness of the release material 170 is formed between the cutting edge 983 and the blade contact surface 971 for the time being by the protrusion 984, the half-cut cutting blade 96 cuts the label 160 without cutting (half cutting) the release material 170.

### Main Unit 2

As shown in FIG. 9 to FIG. 10, the main unit 2 is provided with the peeling portion 4, the pressing portion 5, the opening/closing member 6, and the wrapping portion 7 between metal plates (not shown in the drawings) that reinforce both side surfaces of a base body 20. The base body 20 is made of resin and supports the whole of the main unit 2. A bottom portion of the base body 20 is fixed at a position toward the front right of the base 11. The wrapping portion 7 that wraps the label 160 around the cable 19 is provided in the bottom portion. The rotation body 70 of the wrapping portion 7 is housed in a semi-circular cylindrical housing portion 211 formed in the bottom portion.

A middle portion of the base body 20 is formed above the bottom portion. The middle portion is provided with a peeling region where the label 160 is peeled away. The peeling portion 4, the pressing portion 5, and the opening/closing member 6 are provided in the peeling region. The upper portion of the base body 20 is formed above the middle portion. The upper portion is provided with a first guide path 231 that guides the tape 150 along the transport path R1 to the peeling portion 4, and a second guide path 236 that guides the release material 170 that has been peeled away from the label 160 at the peeling portion 4 to the winding portion 8 along a transport path R2 (refer to FIG. 9). The first guide path 231 has a plate shape and extends diagonally upward and to the front in a side view. The second guide path 236 has a plate shape and extends from the front end of the first guide path 231 diagonally upward and to the rear in a side view. The peeling portion 4 is provided at a connection portion of the first guide path 231 and the second guide path 236.

### Peeling Region

The peeling portion 4 has a round rod shape that extends in the left-right direction. The transport path R1 and the transport path R2 curve at a sharp angle at the peeling portion 4. The peeling portion 4 peels the label 160 away from the release material 170 by tension created by the winding portion 8 winding the tape 150. A coating layer that inhibits the adhesive from attaching when the label 160 is peeled away is formed on the surface of the peeling portion 4.

The opening/closing member 6 has a box shape extending in the up-down direction and is disposed at the front of the base body 20. The opening/closing member 6 opens and closes the housing portion 211 of the wrapping portion 7 by swinging the upper portion in the front-rear direction with a rotation shaft extending in the left-right direction at a lower end portion as the fulcrum. The opening/closing member 6 has a pressing member 60 on a rear surface in the closed state. The pressing member 60 has a pressing surface 61 facing rearward and extending in the up-down direction, which presses the end portion of the label 160 against the cable 19 that passes downward between a guide surface 51 and the pressing surface 61 from the peeling portion 4 toward the wrapping portion 7. The guide surface 51 is disposed on both the left and right sides of the peeling region, extends in the up-down direction, and faces forward. The user grips the cable 19 extending in the left-right direction with both hands and brings the cable 19 into contact with the guide surfaces 51. The guide surfaces 51 guide the cable 19 to which the label 160 that was peeled off at the peeling portion 4 has been affixed, to the wrapping portion 7. The user moves the cable 19 downward along the guide surfaces 51 toward the wrapping portion 7 positioned below the peeling portion 4.

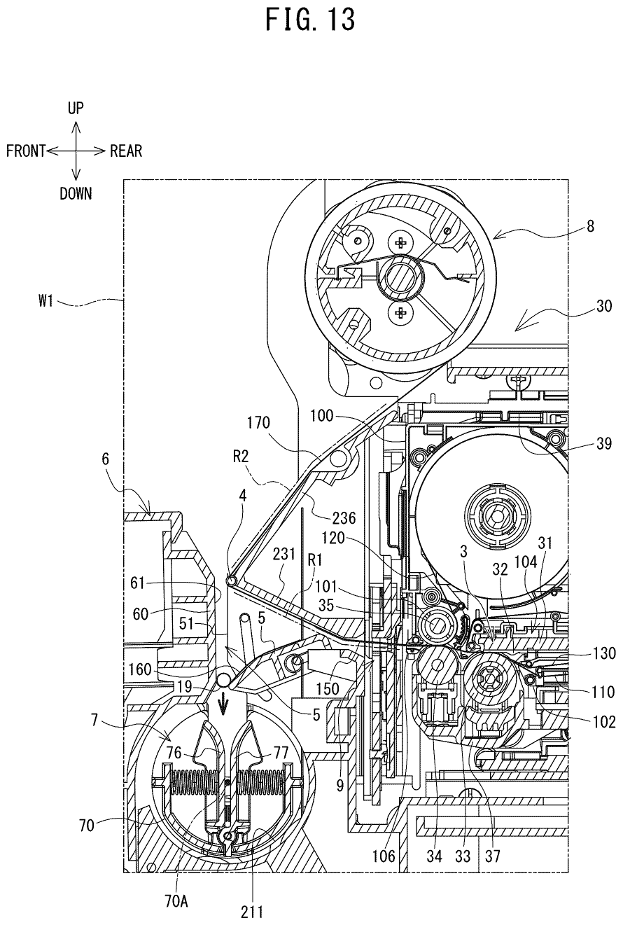

The pressing portion 5 is a portion that presses the end portion of the label 160 against the cable 19 so that the end portion of the label 160 will not peel off in the course of guiding the cable 19, to which the end portion of the label 160 has been affixed, to the wrapping portion 7. The pressing portion 5 is a plate-shaped member disposed below the first guide path 231 and rotatably supported at a rear end portion. The tip end portion of the pressing portion 5 is exposed between the guide surfaces 51 and the pressing surface 61. The pressing portion 5 is urged by a torsion spring (not shown in the drawings) so that the tip end portion is positioned higher than the rear end portion. As shown in FIG. 13, when the user moves the cable 19 downward along the guide surface 51, the pressing portion 5 moves the tip end portion downward with the end portion of the label 160 sandwiched between the tip end portion and the cable 19, maintaining a state in which it is pressed against the cable 19.

### Wrapping Portion 7

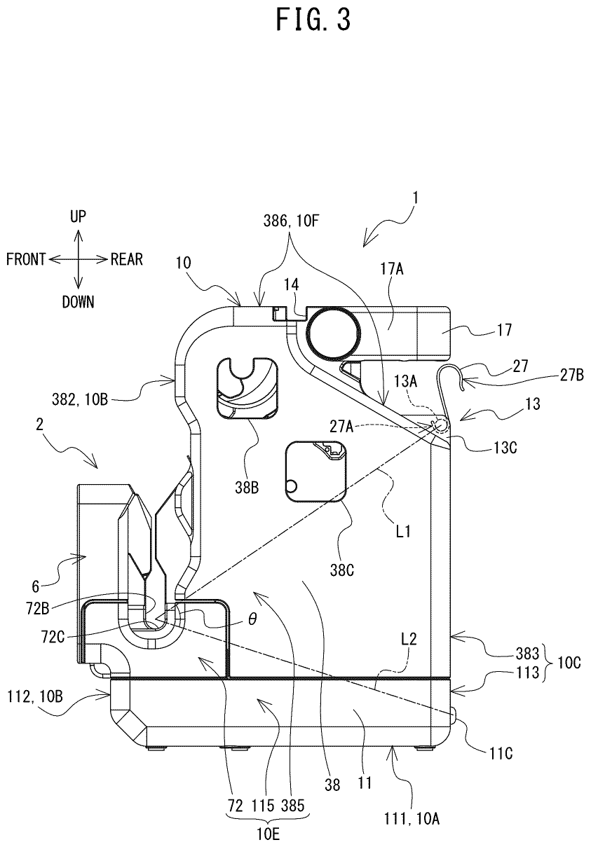

The wrapping portion 7 wraps the label 160, whose end portion is adhered to the cable 19 guided to the guide surfaces 51, around the cable 19 and thus affixes the label 160 to the cable 19. As shown in FIG. 9 and FIG. 10, the wrapping portion 7 has the substantially cylindrical rotation body 70 having a side surface that is partially cut away. The rotational axis center 70A that is a center of rotation of the rotation body 70 extends in the left-right direction. The rotation body 70 is rotatably supported by a left support portion 71 (refer to FIG. 4) fixed to the left surface of the base body 20 and a right support portion 72 (refer to FIG. 1) fixed to the right surface of the base body 20, respectively. The left support portion 71 and the right support portion 72 form the left surface 10D and the right surface 10E at a lower front portion of the housing 10, respectively. The left support portion 71 and the right support portion 72 each have a guide portion 71B and 72B (refer to FIG. 3 and FIG. 4). The guide portions 71B and 72B have a general U shape that is recessed downward from the upper ends of the left support portion 71 and the right support portion 72, respectively, and the portions at the bottom of the U-shaped portions are referred to as bottom portions 71C and 72C. The bottom portions 71C and 72C (refer to FIG. 3 and FIG. 4) have a semicircular shape. The guide portions 71B and 72B guide the cable 19 downward so that the cable 19 reaches the bottom portions 71C and 72C. In order so that the cable 19 will be disposed at a wrapping position, which is a position where the wrapping portion 7 wraps the label 160 around the cable 19, the bottom portions 71C and 72C position the cable 19 on both the left and right sides of the wrapping position. The wrapping position is the position of the rotational axis center 70A of the rotation body 70, or a position in the vicinity thereof.

The rotation body 70 internally houses and swingably supports arm members 76 and 77. The arm members 76 and 77 clamp and hold the cable 19 when the label 160 is wrapped around the cable 19. When the cable 19 is guided by the guide portions 71B and 72B and reaches the bottom portions 71C and 72C, the portion to which the end portion of the label 160 is affixed is disposed near the rotational axis center 70A of the rotation body 70. A microswitch (not shown in the drawings) is provided on each of the bottom portions 71C and 72C. The controller performs control to rotate the rotation body 70 when the two microswitches are both turned on. Rotation of the rotation body 70 causes the arm members 76 and 77 to rotate around the cable 19, thereby wrapping the label 160 around the outer peripheral surface of the cable 19. The label 160 that has been wrapped around the outer peripheral surface of the cable 19 is affixed to the cable 19 by the adhesive.

### Winding Portion 8

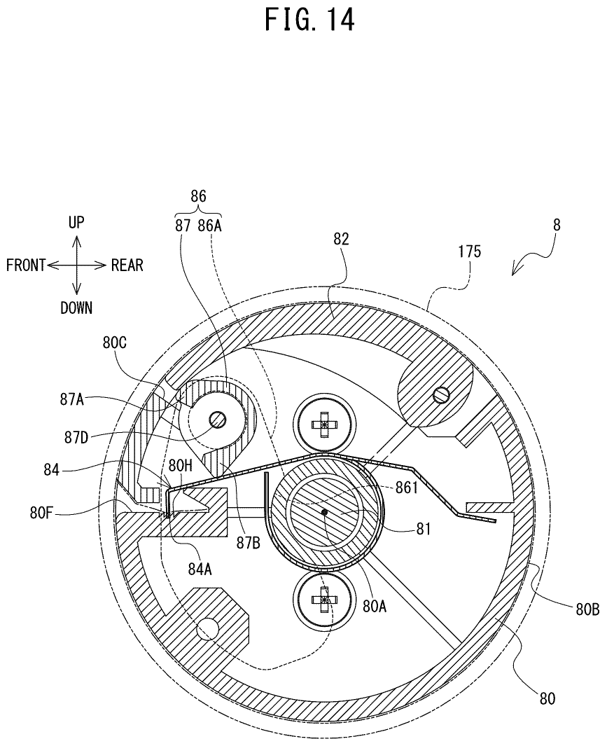

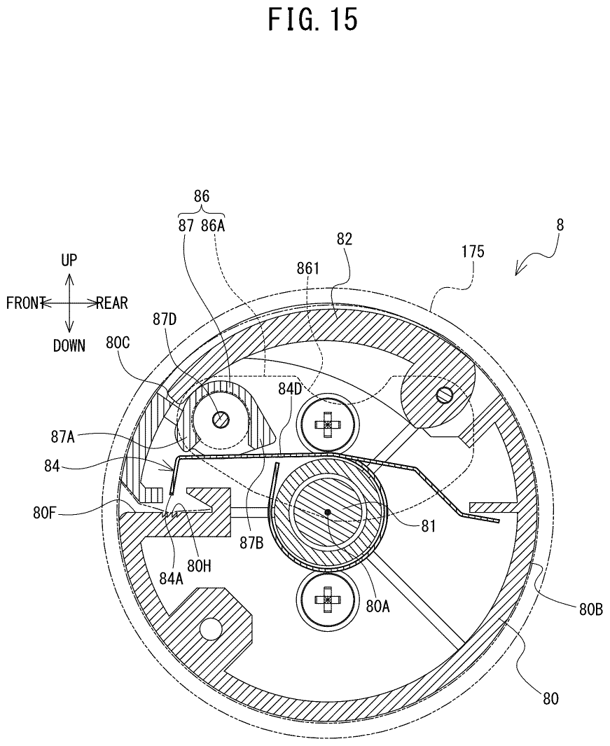

As shown in FIG. 7, FIG. 14, and FIG. 15, the winding portion 8 is positioned diagonally upward and to the rear of the peeling portion 4, and is provided at the right surface of the main plate, above the upper front corner portion of the cassette compartment 39. The winding portion 8 imparts a tension to the tape 150 necessary for the transport of the tape 150 and for the peeling of the label 160, by winding up into a roll shape the release material 170 from which the label 160 has been peeled at the peeling portion 4. The winding portion 8 has a cylindrical shape and a rotational axis center 80A thereof extends in the left-right direction. The length of the winding portion 8 in the left-right direction is greater than the maximum width of the tape 150 (the label 160) corresponding to the label affixing device 1. The left end portion of the winding portion 8 is connected to a drive portion provided at the main plate, and the winding portion 8 rotates in the counterclockwise direction in a right side view, under the control of the controller. The right end portion of the winding portion 8 is free. The release material 170 is wound up onto the outer peripheral surface of the winding portion 8, and at a time of disposal, a release material roll 175 that is in the roll shape is removed to the right from the right end portion.

The winding portion 8 includes the reel 80, a rotation shaft 81, an advancing/retracting member 82, a presser member 84, a lid member 85, and an operation member 86. The reel 80 has a cylindrical shape and extends in an axial direction of the rotational axis center 80A. The left surface of the reel 80 is closed, and the rotation shaft 81 is fixed in the center. The driving force of a motor (not shown in the drawings) provided in the drive portion is transmitted via the rotation shaft 81, and rotates the reel 80 in accordance with the control of the controller.

The right surface of the reel 80 is open. The reel 80 has an open portion 80C that passes through an outer peripheral surface 80B. The advancing/retracting member 82 is disposed in the open portion 80C. The advancing/retracting member 82 has a plate shape of substantially the same size as the breadth of the open portion 80C, and one end side of the advancing/retracting member 82 in the peripheral direction is rotatably supported by the reel 80. The reel 80 has a slit-shaped slot 80F extending in the axial direction, closer to the other end side in the peripheral direction than the open portion 80C, in the outer peripheral surface 80B. The inner wall of the slot 80F extends inside the reel 80 to substantially the center in the radial direction. An end portion of the release material 170 to be wound up by the winding portion 8 is inserted into the slot 80F. The presser member 84 is a metal plate spring. One end portion of the presser member 84 is bent, and a presser portion 84A having a plurality of teeth aligned in the axial direction is formed at an edge section thereof. The presser member 84 bends under pressure applied by a first cam 87A (to be described later), and returns to its original state by elastic force when the pressure is released.

The lid member 85 (refer to FIG. 7) closes the right surface of the reel 80. The lid member 85 includes a removal opening having a long thin cutout shape. The removal opening is formed at a position corresponding to an open section on the right surface of the slot 80F, and is continued to the slot 80F. The end portion of the release material 170 inserted into the slot 80F can be pulled out from the removal opening by sliding the end portion to the right. The operation member 86 moves a free end (the other end in the circumferential direction) of the advancing/retracting member 82 and the presser portion 84A of the presser member 84. The operation member 86 includes an operation portion 86A and a cam member 87. The operation portion 86A includes a rotation shaft 87D, which is inserted into a support hole of the lid member 85, and is rotatably supported. The operation portion 86A is disposed on the right surface of the lid member 85, and rotates between a lock position (refer to FIG. 14) at which the operation portion 86A overlaps with the removal opening and the slot 80F in the axial direction, and a release position (refer to FIG. 15) at which the operation portion 86A does not overlap with the removal opening and the slot 80F in the axial direction.

The cam member 87 is connected to the rotation shaft 87D of the operation portion 86A inside the reel 80. The cam member 87 includes the first cam 87A and a second cam 87B. The first cam 87A changes the position of the free end of the advancing/retracting member 82 in accordance with the rotation of the operation portion 86A. When the operation portion 86A is in the lock position, the first cam 87A pushes the free end of the advancing/retracting member 82 to the outside in the radial direction, thereby placing the advancing/retracting member 82 at an extended position. The extended position is a position in which the position of the outer surface of the advancing/retracting member 82 is substantially the same as the position of the outer peripheral surface 80B of the reel 80 in the radial direction (refer to FIG. 14). When the operation portion 86A is in the release position, the first cam 87A releases the pressure applied to the free end of the advancing/retracting member 82, and the advancing/retracting member 82 is disposed at a retracted position. The retracted position is a position in which the position of the outer surface of the advancing/retracting member 82 is disposed farther inward in the radial direction than the position of the outer peripheral surface 80B of the reel 80 in the radial direction (refer to FIG. 15).

The second cam 87B changes the position of the presser portion 84A of the presser member 84 in accordance with the rotation of the operation portion 86A. When the operation portion 86A is at the lock position, the second cam 87B pushes on the presser member 84, moving the presser portion 84A to a contact position. The contact position is a position at which the presser portion 84A is in contact with a receiving toothed portion 80H formed on the inner wall of the slot 80F (refer to FIG. 14). When the operation portion 86A is at the release position, the second cam 87B releases the pressure applied to the presser member 84. The presser member 84 then returns to its original state by elastic force, and the presser portion 84A consequently moves to a separated position. The separated position is a position at which the presser portion 84A is at a position separated from the receiving toothed portion 80H (refer to FIG. 15).

The operation portion 86A has a cutout portion 861 in which a portion that overlaps with a predetermined circular region centered on the rotational axis center 80A of the reel 80 when the operation portion 86A is in the lock position is cut out in a recessed shape. The portion that overlaps with the predetermined circular region centered on the rotational axis center 80A of the reel 80 when the operation portion 86A is in the release position is not cut out. A protrusion 38D of the compartment cover 38 engages with the cutout portion 861. The protrusion 38D has a pin shape that protrudes to the left from the left surface of the right wall 385 of the compartment cover 38. The protrusion 38D is formed in a position that overlaps with the rotation axis 81 of the reel 80 in the left and right direction when the compartment cover 38 is closed.

When winding up the release material 170 from which the label 160 has been peeled, the user rotates the operation portion 86A and places the operation portion 86A at the release position. The pressure applied to the presser member 84 by the second cam 87B is released and the presser member 84 returns to its original state by elastic force, and consequently, the presser portion 84A moves to the separated position. The user inserts the end portion of the release material 170 into the slot 80F of the reel 80. The end portion of the release material 170 is inserted deep into the slot 80F without coming into contact with the presser portion 84A. The user rotates the operation portion 86A and places the operation portion 86A at the lock position. The presser member 84 is pressed by the second cam 87B, thus moving the presser portion 84A to the contact position. The presser portion 84A clamps the end portion of the release material 170 between the presser portion 84A and the receiving toothed portion 80H. When the compartment cover 38 is closed while the operation portion 86A is in the lock position, the tip end of the protrusion 38D is disposed in the cutout portion 861 of the operation portion 86A. The controller rotates the reel 80 counterclockwise in a right side view and winds up the release material 170. When the compartment cover 38 is closed in a state in which the operation portion 86A is in the release position because the user has forgotten to place the operation portion 86A in the lock position, the tip end of the protrusion 38D will interfere with the operation portion 86A. In this case, the user will not be able to close the compartment cover 38.

When removing the release material roll 175, the user rotates the operation portion 86A and places the operation portion 86A at the release position. The presser portion 84A moves to the separated position. Further, the pressure applied to the advancing/retracting member 82 by the first cam 87A is released, so the advancing/retracting member 82 is able to move to the retracted position. The advancing/retracting member 82 is pushed into the open portion 80C by the release material roll 175 that is firmly wound onto the reel 80, and is placed at the retracted position. A gap is created between the inner surface of the release material roll 175 and the outer surface of the advancing/retracting member 82, so the release material roll 175 moves easily over the outer peripheral surface 80B. The user moves the release material roll 175 in the axial direction, and removes the release material roll 175 from the right end portion of the reel 80. Since the operation portion 86A has moved to the position not overlapping with the removal opening 85A, the user can remove the end portion of the release material 170 to the outside of the slot 80F in the axial direction, through the removal opening 85A.

Incidentally, as shown in FIG. 3, cushioning material 11C extending in the left-right direction is provided on the rear wall 113 of the base 11. When affixing the label 160 to the cable 19, the user grips both ends of the cable 19 with both hands, arranges the cable 19 at the bottom portions 71C and 72C along the guide portions 71B and 72B of the left support portion 71 and the right support portion 72, and turns on the microswitch with the cable 19. When the label affixing device 1 is not disposed on a table or the like, but is used in a state in which the clip 27 is held by the holding member, a downward load is applied to the front of the housing 10 by the operation of placing the cable 19 on the bottom portions 71C and 72C. When a downward load is applied to the front of the housing 10 in a state where the label affixing device 1 is suspended by the clip 27, the label affixing device 1 may rotate around the clip 27 or the attachment bar 13A, making it difficult to affix the label 160. Therefore, when the holding member is made to hold the clip 27, the lower portion of the housing 10 may abut against a wall surface or the like below the holding member, so that rotation is suppressed. The cushioning material 11C inhibits scratching when the lower portion of the housing 10 comes into contact with the wall surface or the like.

Furthermore, the label affixing device 1 defines the position of the attachment portion 13 to be provided on the housing 10 so that the label 160 can be stably affixed when the clip 27 is held by the holding member and the lower portion of the housing 10 is abutted against a wall surface or the like. In the side view, a virtual line connecting the positions of the bottom portions 71C and 72C, which are subjected to a downward load on the front of the housing 10, and the position of the attachment portion 13 is designated as L1. Further, a virtual line connecting the positions of the bottom portions 71C and 72C and the position where the lower portion of the housing 10 abuts against the wall surface or the like (for example, the position of the cushioning material 11C) when the clip 27 is held by the holding member is designated as L2. In this case, it is desirable to provide the attachment portion 13 at a position where an angle θ formed by the virtual line L1 and the virtual line L2 is 45 degrees or more. When the angle θ is less than 45 degrees, a large load is applied to the bottom portions 71C and 72C of the left support portion 71 and the right support portion 72 when the label 160 is affixed, and retention by the clip 27 may become unstable.

Further, although the print portion 3 has weight because of the drive mechanism, the print portion 3 is located closer to the attachment portion 13 than the wrapping portion 7. Therefore, the center of gravity of the label affixing device 1 is positioned closer to the attachment portion 13. Therefore, by providing the attachment portion 13 opposite the print portion 3 from the wrapping portion 7, the stability of holding by the clip 27 can be increased.

As described above, when affixing the label 160 to the cable 19, the cable 19 is inserted into the guide portions 71B and 72B of the left support portion 71 and the right support portion 72 and guided downward toward the bottom portions 71C and 72C. The clip 27 is attached higher than the guide portions 71B and 72B, at the rear surface 10C of the housing 10. When the user places the cable 19 in the bottom portions 71C and 72C, the user pushes the cable 19 so that a load directed downward from the bottom portions 71C and 72C is applied on the label affixing device 1. The clip 27 is higher than the guide portions 71B and 72B, and supports the label affixing device 1 in a state in which the bottom portions 71C and 72C are positioned lower than the clip 27 when the clip 27 holds onto the holding member. Therefore, even if the user inserts the cable 19 into the bottom portions 71C and 72C and a load directed downwards is applied to the label affixing device 1, the clip 27 can stably support the label affixing device 1.

When the label affixing device 1 is hung on a wall by the clip 27 or the clip 27 is attached to the user's belt, a portion (a lower end portion of the rear walls 153, 163, and 383, and the rear wall 113) extending lower than the bottom portions 71C and 72C of the rear surface 10C of the housing 10 abuts against the wall on which the clip 27 is hung, or the user's waist or thigh. Therefore, the clip 27, together with the rear surface 10C of the housing 10, can stably support the label affixing device 1.

When the label affixing device 1 is hung on a wall by the clip 27 or the clip 27 is attached to the user's belt, the portion extending lower than the bottom portions 71C and 72C of the rear surface 10C of the housing 10, and the clip 27, support the label affixing device 1 at an angle of 45 degrees or more with respect to the bottom portions 71C and 72C. Therefore, the clip 27, together with the rear surface 10C of the housing 10, can stably support the label affixing device 1.

Although the print portion 3 has a weight, it is positioned closer to the attachment portion 13 than the wrapping portion 7. Since the center of gravity is close to the clip 27, the moment of force generated when supported by the clip 27 can be reduced. Therefore, the clip 27, together with the rear surface 10C of the housing 10, can stably support the label affixing device 1.

The print portion 3, the transport roller 34 and the drive roller 101, the first guide path 231, the winding portion 8, and a second guide path 236 are housed in the compartment 30. Therefore, the compartment 30 has weight. The label 160 is peeled off from the release material 170 by the peeling portion 4, affixed to the cable 19, and inserted downward into the wrapping portion 7. Therefore, the compartment 30 is positioned closer to the attachment portion 13 than the wrapping portion 7. Since the center of gravity is close to the clip 27, the moment of force generated when supported by the clip 27 can be reduced. Therefore, the clip 27, together with the rear surface 10C of the housing 10, can stably support the label affixing device 1.

When the operation portion 86A of the reel 80 is not in the lock position when the compartment cover 38 is closed, the protrusion 38D of the compartment cover 38 will interfere with the operation portion 86A, so that the compartment cover 38 cannot close the compartment 30. Therefore, when the user can close the compartment cover 38, the user can know that the operation portion 86A is in the lock position without having to visually check.

Because the half-cut cutting blade 96 is controlled in cooperation with the print portion 3 in creating the label 160, driving by the motor MT is necessary. On the other hand, the full-cut cutting blade 91 cuts the release material 170 when the rolled release material 170 is removed from the reel 80. Since control for driving the full-cut cutting blade 91 is not necessary in this case, control is performed manually by the operation of the lever 90. With this configuration, the label affixing device 1 enables the number of parts and, consequently, the cost to be reduced.

The protrusion 15C protrudes farther than the operation portion 86A of the lever 90 protruding from the open portion 15B. When operating the operation portion 86A of the lever 90, the user touches it while avoiding the protrusion 15C. Therefore, the protrusion 15C can inhibit accidental operation of the lever 90 by the user. Further, in the event that the label affixing device 1 falls over, the protrusion 15C will strike the object being struck before the operation portion 86A of the lever 90. Therefore, the protrusion 15C can protect the operation portion 86A portion of the lever 90 from damage and the like.

Since the attachment bar 13A has a long extended shape, the clip 27 easily supports the attachment bar 13A so that the attachment bar 13A will not tilt in the direction in which the attachment bar 13A extends. The attachment bar 13A extends in a direction parallel to the rotational axis center 70A of the rotation body 70. Therefore, when the cable 19 is inserted into the bottom portions 71C and 72C, a load may be applied in the direction in which the rotational axis center 70A is tilted depending on the posture of the cable 19. Even in such a case, the clip 27 suppresses tilting of the rotational axis center 70A by suppressing tilting of the attachment bar 13A, and thus can stably support the label affixing device 1.

Since the clip 27 is attached to the attachment portion 13, the user can immediately hang the label affixing device 1 on the wall with the clip 27 or attach the clip 27 to the user's belt at a work site.

### Other

In the above embodiment, the wrapping portion 7 is one example of the “rotation doby” of the present disclosure. The cable 19 is one example of the “adherend” of the present disclosure. The bottom portions 71C and 72C are examples of the “insertion positions” of the present disclosure. The portion of the left surface 10D of the housing 10 that is formed by the left support portion 71 is one example of the “first surface” of the present disclosure. The portion of the right surface 10E of the housing 10 that is formed by the right support portion 72 is one example of the “second surface” of the present disclosure. The downward direction is one example of the “insertion direction” of the present disclosure. The guide portions 71B and 72B are examples of the “insertion paths” of the present disclosure. The left-right direction is one example of the “facing direction” of the present disclosure. The front-rear direction is one example of the “intersecting direction” of the present disclosure. The top surface 10F or the rear surface 10C of the housing 10 is one example of the “third surface” of the present disclosure. The print portion 3 is one example of the “print head” of the present disclosure. The drive roller 101 and the transport roller 34 are examples of the “feed-out portion” of the present disclosure. The compartment cover 38 is one example of the “cover” of the present disclosure. The half-cut cutting blade 96 is one example of the “half cutter” of the present disclosure. The motor MT is one example of the “drive source” of the present disclosure. The full-cut cutting blade 91 is one example of the “full cutter” of the present disclosure. The attachment bar 13A is one example of the “bar member” of the present disclosure. The arm portion 17A is one example of the “arm” of the present disclosure.

### Modified Examples

While the disclosure has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the disclosure, and not limiting the disclosure. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described disclosure are provided below:
The method of printing by the print portion 3 is not limited to the above embodiment. For example, the label affixing device 1 may perform printing using a receptor-type tape cassette. In this case, a tape, in which a base material and a release material that is bonded to an adhesive surface of the base material coated with an adhesive are laminated together, and an ink ribbon are housed in the tape cassette. The print portion 3 performs printing on a surface of the tape that is opposite the adhesive surface. Note that the tape may use, for example, a die-cut label cut to a predetermined size as a base material.

The label affixing device 1 need not have the print portion 3 or the cutting portion 9. The printing on the tape 150 may be performed by an external printing device. The label affixing device 1 may use the tape 150 printed by the printing device and wrap the label around the cable 19 and affix it thereto. The object to which the label 160 is affixed is not limited to the cable 19, and may be another adherend. In addition, the adhesive surface of the tape 150 is not limited to one coated with an adhesive; adhesion may be obtained by processing.

The clip 27 is not limited to an S-shaped plate-shaped hook, but may also be a metal fitting in which the holding member can be sandwiched between two plate-shaped portions using, for example, an elastic member. Alternatively, the clip 27 may be a band-shaped fixing belt that hangs the label affixing device 1 on the holding member via the attachment bar 13A and the top walls 156 and 386.

The amount that the protrusion 15C of the left wall 154 of the left cover 15 protrudes to the left is greater than the amount that the operation portion 902 of the lever 90 of the full-cut cutting blade 91 protrudes to the left beyond the left wall 154, but it may be the same.

The fixing portions 13B and 13C of the attachment portion 13 are respectively positioned at the upper end portions of the rear surface 10C of the housing 10, on both sides in the left-right direction, but they do not necessarily have to be positioned at both ends in the left-right direction. For example, the fixing portions 13B and 13C may be provided at a position where the length of the middle portion of the attachment bar 13A is slightly greater than the width of the end portion 27A of the clip 27. In addition, the attachment portion 13 may be provided in plurality. For example, one may be provided at the left end portion and one at the right end portion, respectively, at the upper end portion of the rear surface 10C. Furthermore, the attachment portions 13 may be connected by a belt or the like, and the label affixing device 1 may be held by the holding member by hooking the belt or the like on the holding member.

Further, the attachment portion 13 is provided in a corner portion between the rear end of the top walls 156 and 166 and the upper end of the rear walls 153 and 163, but the attachment portion 13 may be provided in a position on the front of the rear end of the top walls 156 and 166, or in a position below the upper end of the rear walls 153 and 163.

The label affixing device may include a rotation body in which an adherend to which a portion of a label that is an object to be affixed has been affixed is inserted to an insertion position, the rotation body being configured to wrap and affix the label around the adherend by rotating; a housing configured to rotatably support the rotation body; and an attachment portion provided with a bar member disposed on the housing, and configured to accept an attachment of a clip sandwiching and holding a holding member, wherein the housing is provided with a first surface, a second surface facing the first surface, and a third surface intersecting the first surface and the second surface, an insertion path extending in an insertion direction in which the adherend is inserted toward the insertion position and configured to guide the adherend to the insertion position is disposed on each of the first surface and the second surface, and the attachment portion is disposed farther opposite to the insertion direction than the insertion path, on the third surface, at a position away from the insertion position in an intersecting direction intersecting the insertion direction and intersecting a facing direction of the first surface and the second surface.

When affixing the label to the adherend, the adherend is inserted into the insertion path between the first surface and the second surface, and guided in the insertion direction toward the insertion position of the rotation body. The clip is attached to the third surface opposite the insertion direction from the insertion path. When a user places the adherend at the insertion position, a load in the insertion direction is applied to the label affixing device from the insertion position by the user pushing on the adherend. The clip is positioned opposite the insertion direction from the insertion path, so when the clip holds the holding member, the label affixing device is supported in a state in which the insertion position is farther in the insertion direction than the clip. Therefore, even if the user inserts the adherend to the insertion position and a load in the insertion direction is applied to the label affixing device, the clip can stably support the label affixing device.

The label affixing device described above may further include a print head configured to print an image on the label is provided, wherein the print portion is positioned between the attachment portion and the rotation body.

With the label affixing device described above, although the print head has a weight, it is positioned closer to the attachment portion than the rotation body. Since the center of gravity is close to the clip, the moment of force generated when supported by the clip can be reduced. Therefore, the clip, together with the third surface of the housing, can stably support the label affixing device.

What is claimed is:

1. A label affixing device, comprising:
a rotation body in which an adherend to which a portion of a label that is an object to be affixed has been affixed is inserted to an insertion position, the rotation body being configured to wrap and affix the label around the adherend by rotating;
a housing configured to rotatably support the rotation body; and
an attachment portion provided with a bar member disposed on the housing, and configured to accept an attachment of a clip sandwiching and holding a holding member.

2. The label affixing device according to claim 1, wherein
the housing is provided with a first surface, a second surface facing the first surface, and a third surface intersecting the first surface and the second surface, and an insertion path extending in an insertion direction in which the adherend is inserted toward the insertion position, and configured to guide the adherend to the insertion position is disposed on each of the first surface and the second surface, and the attachment portion is disposed farther opposite to the insertion direction than the insertion path, on the third surface, at a position away from the insertion position in an intersecting direction intersecting the insertion direction and intersecting a facing direction of the first surface and the second surface.

3. The label affixing device according to claim 2, wherein
the third surface is a surface intersecting the intersecting direction, and extends farther in the insertion direction than the insertion position.

4. The label affixing device according to claim 3, wherein
when the label affixing device is viewed in the facing direction, an angle formed between a first virtual line and a second virtual line is equal to or greater than 45 degrees, the first virtual line connects the insertion position and the attachment portion, and the second virtual line connects the insertion position and a portion of the third surface extending farther in the insertion direction than the insertion position.

5. The label affixing device according to claim 1, further comprising:
a print head configured to print an image on the label, wherein
the housing is provided with a first surface, and a second surface facing the first surface, and
the print head is positioned between the attachment portion and the rotation body in an intersecting direction intersecting an insertion direction in which the adherend is inserted toward the insertion position, and intersecting a facing direction of the first surface and the second surface.

6. The label affixing device according to claim 5, wherein
the housing is provided with a compartment configured to accommodate a tape cassette housing a tape in which the label is affixed to a release material, and
the compartment includes
the print head,
a feed-out portion configured to feed out the tape, in which printing was performed on the label in the print head, toward a peeling portion configured to peel the label from the release material,
a first guide path configured to guide the tape fed out by the feed-out portion to the peeling portion,
a winding portion configured to wind up the release material from which the label was peeled by the peeling portion, and
a second guide path configured to guide the release material from the peeling portion to the winding portion.

7. The label affixing device according to claim 6, wherein
the winding portion is provided with
a reel rotatably supported by a rotation axis extending in the facing direction, and configured to wind up the release material on an outer peripheral surface thereof,
a slot opened in the outer peripheral surface and into which an end portion of the release material is inserted,
a presser portion configured to press the end portion of the release material inserted into the slot into the slot, and
an operation portion disposed on a side surface on one side of the reel in the facing direction and connected to the presser portion, and configured to move between a lock position in which the end portion of the release material is pressed into the slot by the presser portion, and a release position in which pressure applied to the end portion of the release material by the presser portion is released,
the housing is provided with a cover covering the compartment,
the cover is provided with a protrusion extending toward the side surface on the one side of the reel when the cover is closed, and
when the cover is closed, the protrusion interferes with the operation portion when the operation portion is in the release position, and does not interfere with the operation portion when the operation portion is in the lock position.

8. The label affixing device according to claim 6, wherein
the compartment has a cutting portion disposed between the feed-out portion and the first guide path, and configured to cut the label on which an image has been printed by the print head, and
the cutting portion is provided with
a half cutter configured to cut the tape, leaving the release material, and forming the label in the form of a single sheet,
a drive source configured to drive the half cutter,
a full cutter configured to cut away the tape, and
a lever configured to operate the full cutter by an operation.

9. The label affixing device according to claim 8, wherein
the housing has
an open portion through which an operation portion of the lever protrudes outside of the housing, and
a protrusion formed on an edge portion of a peripheral edge portion of the open portion, opposite the insertion direction, and configured to protrude a same amount or more than a amount the operation portion of the lever protrudes from the open portion.

10. The label affixing device according to claim 1, wherein
the rotation body rotates around a rotation axis, and
the attachment portion is provided with the bar member extending in a direction parallel to the rotation axis.

11. The label affixing device, according to claim 1, wherein
the clip configured to sandwich and hold onto the holding member is attached to the attachment portion.

12. The label affixing device according to claim 1, further comprising:
a handle disposed on the housing and having an arm, and configured to be used to carry the label affixing device is provided, wherein
the handle is configured to move between a first position where the arm extends in an insertion direction in which the adherend is inserted toward the insertion position, and a second position where the arm extends intersecting the insertion direction.

13. The label affixing device according to claim 12, wherein
when the label affixing device is viewed in the insertion direction, the attachment portion is disposed in a position overlapping with the handle in the second position, and disposed in a position not overlapping with the handle in the first position.

14. The label affixing device according to claim 1, wherein
the housing is provided with a groove configured to accommodate a part of a mobile terminal.

15. The label affixing device according to claim 14, further comprising:
a handle disposed on the housing and having an arm, and configured to be used to carry the label affixing device is provided, wherein
when the label affixing device is viewed in an insertion direction in which the adherend is inserted toward the insertion position, the groove is disposed at a position not overlapping with the handle in a first position where the arm extends in the insertion direction or a second position where the arm extends intersecting the insertion direction.

16. The label affixing device according to claim 2, wherein
the housing is provided with an opening/closing member configured to swing with a rotation axis extending in the facing direction as a fulcrum, and having a surface member defining the insertion path in a closed state.

17. The label affixing device according to claim 16, further comprising:
a print head configured to print an image on the label, wherein
the print head is positioned between the attachment portion and the rotation body in the intersecting direction intersecting the insertion direction, and intersecting a facing direction of the first surface and the second surface, and
in the intersecting direction, the opening/closing member is positioned opposite the attachment portion sandwiching the print head.

18. A label affixing device comprising:
a rotation body in which an adherend to which a portion of a label that is an object to be affixed has been affixed is inserted to an insertion position, the rotation body being configured to wrap and affix the label around the adherend by rotating;
a housing configured to rotatably support the rotation body; and
a clip disposed on the housing and configured to sandwich and hold a holding member.
